(19) United States
(12) Patent Application Publication
(10) Pub. No.: US 2026/0072426 A1
(43) Pub. Date: Mar. 12, 2026

(54) INFORMATION PROCESSING METHOD, INFORMATION PROCESSING DEVICE, AND PROGRAM

(71) Applicant: PANASONIC INTELLECTUAL PROPERTY MANAGEMENT CO., LTD., Osaka (JP)

(72) Inventor: Ryosuke NAGUMO, Tokyo (JP)

(21) Appl. No.: 19/393,992

(22) Filed: Nov. 19, 2025

Related U.S. Application Data
(63) Continuation of application No. PCT/JP2024/017878, filed on May 15, 2024.

(30) Foreign Application Priority Data
May 24, 2023 (JP) 2023-085291

(51) Int. Cl. G05B 23/02

(52) U.S. Cl. CPC G05B 23/0221

(57) ABSTRACT

An information processing method is implemented by an information processing device and involves: acquiring a command signal for driving the servo motor and measurement data measured with respect to the servo motor or to the control target device when the servo motor performs an operation on the basis of the command signal; calculating an abnormality degree of the operation of the servo motor on the basis of the command signal and the measurement data; displaying the measurement data and the abnormality degree on a display device; acquiring, from an input device, setting information of an allowable range which is variably set by a user operation on the basis of the displayed measurement data; setting the threshold value on the basis of the setting information; and further displaying the set threshold value on the display device in accordance with the abnormality degree.

### FIELD OF INVENTION

The present disclosure relates to an information processing method, an information processing device, and a program.

### BACKGROUND ART

An abnormality detection device according to the background art is disclosed in, for example, Patent Literature 1.

In the abnormality detection device according to the related art, a threshold value for abnormality determination is fixedly set to a value of plus or minus 10% of a reference torque generated by a servo motor.
Patent Literature 1: JP 2020-65364 A

### SUMMARY OF THE INVENTION

An object of the present disclosure is to provide an information processing method, an information processing device, and a program capable of variably setting a threshold value for determining whether an operation of a servo motor is normal or abnormal by a user operation.

An information processing method according to an aspect of the present disclosure is for setting a threshold value which is for determining whether an operation of a servo motor that controls a control target device is normal or abnormal. The method is implemented by an information processing device and involves acquiring a command signal for driving the servo motor and measurement data measured for the servo motor or the control target device when the servo motor performs an operation on the basis of the command signal, calculating an abnormality degree of the operation of the servo motor on the basis of the command signal and the measurement data, displaying the measurement data and the abnormality degree on a display device, acquiring, from an input device, setting information of an allowable range which is variably set by a user operation on the basis of the displayed measurement data, setting the threshold value on the basis of the setting information, and causing the display device to further display the set threshold value in association with the abnormality degree.

### BRIEF DESCRIPTION OF THE DRAWINGS

FIG. 1 is a simplified diagram showing a configuration of a state determination device according to an embodiment of the present disclosure.

FIG. 2 is a flowchart showing processing executed by an information processing unit.

FIG. 3 is a diagram showing an example of a screen displayed on a display device.

FIG. 4 is a diagram showing a setting example of an operation period.

FIG. 5 is a flowchart showing processing executed by the information processing unit.

FIG. 6 is a diagram showing an example of the screen displayed on the display device.

### DETAILED DESCRIPTION

### Knowledge Underlying Present Disclosure

In a servo motor abnormality detection device according to the related art, a threshold value for determining whether an operation of a servo motor is normal or abnormal is fixedly set. In the abnormality detection device disclosed in Patent Literature 1, for example, a threshold value for abnormality determination is fixedly set to a value of plus or minus 10% of a reference torque generated by a servo motor.

However, since requirement for the accuracy of abnormality detection varies depending on the circumstances of a user or the like, there is a demand for the user to arbitrarily set the threshold value for abnormality determination.

In order to solve such a problem, the present inventors have found that a threshold value for abnormality determination can be arbitrarily set by a user by causing a display device to display measurement data when a servo motor performs an operation on the basis of a command signal and an abnormality degree of an operation of the servo motor, causing the user to set an allowable range on the basis of the displayed measurement data, and setting a threshold value on the basis of setting information of the allowable range, and have arrived at the present disclosure.

Next, each aspect of the present disclosure will be described.

An information processing method according to a first aspect of the present disclosure is for setting a threshold value for determining whether an operation of a servo motor that controls a control target device is normal or abnormal, the method including, by an information processing device, acquiring a command signal for driving the servo motor and measurement data measured for the servo motor or the control target device when the servo motor performs an operation on the basis of the command signal, calculating an abnormality degree of the operation of the servo motor on the basis of the command signal and the measurement data, displaying the measurement data and the abnormality degree on a display device, acquiring, from an input device, setting information of an allowable range which is variably set by a user operation on the basis of the displayed measurement data, setting the threshold value on the basis of the setting information, and causing the display device to further display the set threshold value in association with the abnormality degree.

In the first aspect, the measurement data and the abnormality degree are displayed on the display device, and the setting information of the allowable range variably set by the user operation on the basis of the displayed measurement data is acquired from the input device, and thus the threshold value for determining whether the operation of the servo motor is normal or abnormal can be variably set by the user operation.

In an information processing method according to a second aspect of the present disclosure, in the first aspect, preferably, an operation period of the servo motor includes a plurality of operation periods including an acceleration period, a deceleration period, and a constant-speed period, the allowable range is individually set for each of the plurality of operation periods, and the threshold value is individually set for each of the plurality of operation periods.

In the second aspect, the threshold value is individually set for each of the plurality of operation periods to enable detailed abnormality detection.

In an information processing method according to a third aspect of the present disclosure, in the second aspect, preferably, the constant-speed period includes a transient period including an initial period of the constant-speed period and a steady period including an end period of the constant-speed period, the allowable range is individually set for the transient period and the steady period, and the threshold value is individually set for the transient period and the steady period.

In the third aspect, the threshold value is individually set for the transient period and the steady period to enable more detailed abnormality detection.

In an information processing method according to a fourth aspect of the present disclosure, in any one of the first to third aspects, preferably, the allowable range is individually set in an excess direction and a deficiency direction for the measurement data, and the threshold value is individually set in the excess direction and the deficiency direction.

In the fourth aspect, the threshold value is individually set in the excess direction and the deficiency direction for the measurement data to enable detailed abnormality detection.

In an information processing method according to a fifth aspect of the present disclosure, in any one of the first to fourth aspects, preferably, in display of the threshold value, the threshold value is increased or decreased in conjunction with setting of the allowable range by the user operation and displayed on the display device.

In the fifth aspect, the threshold value is increased or decreased in conjunction with the setting of the allowable range by the user operation and displayed on the display device to improve convenience of the user.

An information processing method according to a sixth aspect of the present disclosure preferably further includes, in any one of the first to fifth aspects, acquiring, from the input device, adjustment information of the threshold value variably adjusted by a user operation on the basis of the threshold value displayed, and adjusting the threshold value set on the basis of the adjustment information.

In the sixth aspect, since the threshold value can be directly adjusted by the user operation in addition to the setting of the allowable range, the convenience of the user can be improved.

In an information processing method according to a seventh aspect of the present disclosure, in the sixth aspect, preferably, the allowable range is further increased or decreased in conjunction with adjustment of the threshold value by the user operation and displayed on the display device.

In the seventh aspect, the allowable range is increased or decreased in conjunction with the adjustment of the threshold value by the user operation and displayed on the display device to further improve the convenience of the user.

In an information processing method according to an eighth aspect of the present disclosure, in any one of the first to seventh aspects, preferably, in the calculating of the abnormality degree, the abnormality degree is calculated by using a machine-learned estimation model that estimates and outputs an abnormality degree on a basis of a command signal and measurement data input.

In the eighth aspect, the abnormality degree can be calculated with high accuracy by using the machine-learned estimation model.

An information processing method according to a ninth aspect of the present disclosure for setting a threshold value for determining whether an operation of a servo motor for controlling a control target device is normal or abnormal preferably includes, by an information processing device, acquiring a command signal for driving the servo motor and measurement data measured by the servo motor or the control target device when the servo motor performs an operation on the basis of the command signal, calculating an abnormality degree of the operation of the servo motor on the basis of the command signal and the measurement data, setting a reference threshold value on the basis of the command signal and the measurement data, a display control unit that causes a display device to display the measurement data, the abnormality degree, and the reference threshold value in association with the abnormality degree, acquiring, from an input device, setting information of the threshold value variably set by a user operation on the basis of the reference threshold value displayed, setting an allowable range of the measurement data on the basis of the threshold value set, and causing the display device to further display the allowable range set in association with the measurement data.

In the ninth aspect, the measurement data, the abnormality degree, and the reference threshold value are displayed on the display device, and the setting information of the threshold value variably set by the user operation on the basis of the displayed reference threshold value is acquired from the input device, and thus the threshold value for determining whether the operation of the servo motor is normal or abnormal can be variably set by the user operation.

In an information processing method according to a tenth aspect of the present disclosure, in the ninth aspect, preferably, in displaying of the allowable range, the allowable range is increased or decreased in conjunction with setting of the threshold value by the user operation and displayed on the display device.

In the tenth aspect, the allowable range is increased or decreased in conjunction with the setting of the threshold value by the user operation and displayed on the display device to improve convenience of the user.

An information processing device according to an eleventh aspect of the present disclosure sets a threshold value for determining whether an operation of a servo motor that controls a control target device is normal or abnormal, and includes a data acquisition unit that acquires a command signal for driving the servo motor and measurement data measured for the servo motor or the control target device when the servo motor performs an operation on the basis of the command signal, a calculation unit that calculates an abnormality degree of the operation of the servo motor on the basis of the command signal and the measurement data, a display control unit that causes a display device to display the measurement data and the abnormality degree, an information acquisition unit that acquires, from an input device, setting information of an allowable range variably set by a user operation on the basis of the measurement data displayed, and a setting unit that sets the threshold value on the basis of the setting information, in which the display control unit causes the display device to further display the threshold value set in association with the abnormality degree.

In the eleventh aspect, the measurement data and the abnormality degree are displayed on the display device, and the setting information of the allowable range variably set by the user operation on the basis of the displayed measurement data is acquired from the input device, and thus the threshold value for determining whether the operation of the servo motor is normal or abnormal can be variably set by the user operation.

An information processing device according to a twelfth aspect of the present disclosure sets a threshold value for determining whether an operation of a servo motor for controlling a control target device is normal or abnormal, and includes a data acquisition unit that acquires a command signal for driving the servo motor and measurement data measured by the servo motor or the control target device when the servo motor performs an operation on the basis of the command signal, a calculation unit that calculates an abnormality degree of the operation of the servo motor on the basis of the command signal and the measurement data, a setting unit that sets a reference threshold value on the basis of the command signal and the measurement data, a display control unit that causes a display device to display the measurement data, the abnormality degree, and the reference threshold value in association with the abnormality degree, and an information acquisition unit that acquires, from an input device, setting information of the threshold value variably set by a user operation on the basis of the reference threshold value displayed, in which the setting unit further sets an allowable range of the measurement data on the basis of the threshold value set, and the display control unit causes the display device to further display the allowable range set in association with the measurement data.

In the twelfth aspect, the measurement data, the abnormality degree, and the reference threshold value are displayed on the display device, and the setting information of the threshold value variably set by the user operation on the basis of the displayed reference threshold value is acquired from the input device, and thus the threshold value for determining whether the operation of the servo motor is normal or abnormal can be variably set by the user operation.

A program according to a thirteenth aspect of the present disclosure causes an information processing device that sets a threshold value for determining whether an operation of a servo motor that controls a control target device is normal or abnormal to execute processing, in which the information processing device, by execution of the program, acquires a command signal for driving the servo motor and measurement data measured for the servo motor or the control target device when the servo motor performs an operation on the basis of the command signal, calculates an abnormality degree of the operation of the servo motor on the basis of the command signal and the measurement data, causes a display device to display the measurement data and the abnormality degree, acquires, from an input device, setting information of an allowable range variably set by a user operation on the basis of the measurement data displayed, sets the threshold value on the basis of the setting information, and causes the display device to further display the threshold value set in association with the abnormality degree.

In the thirteenth aspect, the measurement data and the abnormality degree are displayed on the display device, and the setting information of the allowable range variably set by the user operation on the basis of the displayed measurement data is acquired from the input device, and thus the threshold value for determining whether the operation of the servo motor is normal or abnormal can be variably set by the user operation.

A program according to a fourteenth aspect of the present disclosure causes an information processing device that sets a threshold value for determining whether an operation of a servo motor for controlling a control target device is normal or abnormal to execute processing, in which the information processing device, by execution of the program, acquires a command signal for driving the servo motor and measurement data measured by the servo motor or the control target device when the servo motor performs an operation on the basis of the command signal, calculates an abnormality degree of the operation of the servo motor on the basis of the command signal and the measurement data, sets a reference threshold value on the basis of the command signal and the measurement data, a display control unit that causes a display device to display the measurement data, the abnormality degree, and the reference threshold value in association with the abnormality degree, acquires, from an input device, setting information of the threshold value variably set by a user operation on the basis of the reference threshold value displayed, further sets an allowable range of the measurement data on the basis of the threshold value set, and causes the display device to further display the allowable range set in association with the measurement data.

In the fourteenth aspect, the measurement data, the abnormality degree, and the reference threshold value are displayed on the display device, and the setting information of the threshold value variably set by the user operation on the basis of the displayed reference threshold value is acquired from the input device, and thus the threshold value for determining whether the operation of the servo motor is normal or abnormal can be variably set by the user operation.

The present disclosure can also implement each characteristic configuration included in such a method or device as a program to be executed by a computer or as a system operated by this program. It is needless to say that such a computer program can be distributed via a computer-readable non-transitory recording medium such as a CD-ROM or via a communication network such as the Internet.

### Embodiments of Present Disclosure

Embodiments of the present disclosure will be described below in detail with reference to the drawings. Elements denoted with the same reference symbol in different drawings represent the same or corresponding elements. Constituent elements, placement positions of the constituent elements, connection forms, the order of operations, and the like shown in the following embodiments are an example, and are not intended to limit the present disclosure. The present disclosure is limited only by the claims. Therefore, a constituent element that is not described in an independent claim indicating the most generic concept of the present disclosure among constituent elements in the following embodiments is not necessarily required to achieve the object of the present disclosure, but the constituent element is described as constituting a more preferable form.

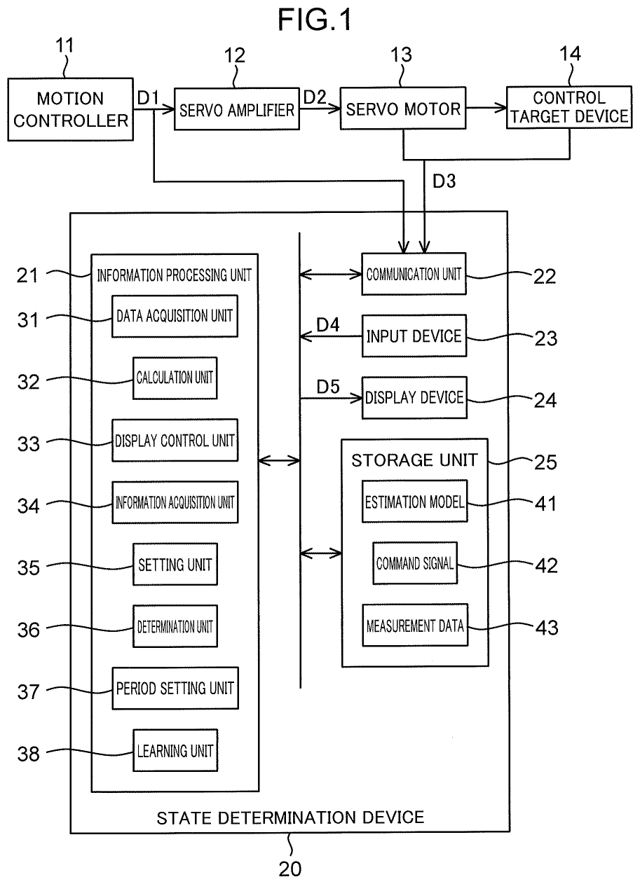

FIG. 1 is a simplified diagram showing a configuration of a state determination device 20 according to an embodiment of the present disclosure. The state determination device 20 sets a threshold value H for abnormality determination of the servo motor 13, and determines whether the operation of the servo motor 13 is normal or abnormal by using the set threshold value H. The servo motor 13 may be a rotary motor or a linear motor. The state determination device 20 may be a dedicated terminal, a general-purpose PC, or a server device. The function of the state determination device 20 may be implemented in a motion controller 11.

The abnormality of the servo motor 13 includes, in addition to the abnormality of the servo motor 13, an abnormality of a control target device 14 whose operation is controlled by the servo motor 13. The control target device 14 is, for example, a production device used to produce a machine. The production device includes a mounting device, a processing device, a machining device, a conveyance device, or the like for mounting, processing, machining, conveying, or the like of a machine. The production device is installed, for example, in a production line of a factory.

The motion controller 11 outputs a command signal D1. The command signal D1 includes a position command signal, a speed command signal, a torque command signal, or the like for specifying a moving position, moving speed, generated torque, or the like of the servo motor 13. The servo amplifier 12 drives the servo motor 13 on the basis of the command signal D1 input from the motion controller 11. The command signal D1 is input to the state determination device 20. Measurement data D3 is input to the state determination device 20. The measurement data D3 is data measured for the servo motor 13 or the control target device 14 when the servo motor 13 operates on the basis of the command signal D1. The measurement data D3 includes, for example, position data measured by a position sensor, torque data measured by a torque sensor, temperature data measured by a temperature sensor, or current data measured by a current sensor.

The state determination device 20 includes an information processing unit 21, a communication unit 22, an input device 23, a display device 24, and a storage unit 25.

The information processing unit 21 is configured by using a processor such as a CPU. The information processing unit 21 includes a data acquisition unit 31, a calculation unit 32, a display control unit 33, an information acquisition unit 34, a setting unit 35, a determination unit 36, a period setting unit 37, and a learning unit 38 as functions implemented by the processor executing a program read from a non-volatile recording medium such as a computer-readable ROM. In other words, the program is a program for causing the information processing unit 21 as an information processing device mounted in the state determination device 20 to function as the data acquisition unit 31 (data acquisition means), the calculation unit 32 (calculation means), the display control unit 33 (display control means), the information acquisition unit 34 (information acquisition means), the setting unit 35 (setting means), the determination unit 36 (determination means), the period setting unit 37 (period setting means), and the learning unit 38 (learning means). Details of a processing content executed by each processing unit will be described later.

The communication unit 22 includes a communication module corresponding to an arbitrary communication scheme such as a dedicated line network or a public line network.

The input device 23 includes a mouse, a keyboard, a touch panel, or the like that can be operated by the user.

The display device 24 includes a liquid crystal display, an organic EL display, or the like that can be visually recognized by the user who operates the input device 23.

The storage unit 25 includes an HDD, an SSD, a semiconductor memory, or the like. The storage unit 25 holds an estimation model 41, a command signal 42, and measurement data 43. The estimation model 41 is a machine-learned estimation model having the command signal D1 and the measurement data D3 as explanatory variables and the abnormality degree of the operation of the servo motor 13 as an objective variable. The estimation model 41 is machine-learned by unsupervised learning using a large number of pieces of normal data by the learning unit 38, for example. The estimation model 41 estimates and outputs an abnormality degree N by using a predetermined algorithm on the basis of the command signal D1 and measurement data D3 that have been input. For example, the estimation model 41 estimates and outputs the abnormality degree N by using an algorithm such as a Mahalanobis' distance, k-NN, a decision tree, SVM, or Naive Bayes on the basis of the speed command signal included in the command signal D1 and the torque data included in the measurement data D3. The abnormality degree N is an index representing a degree of deviation from the normal data, and the value of the abnormality degree N also increases as the degree of deviation from the normal data increases, and the value of the abnormality degree N also decreases as the degree of deviation from the normal data decreases.

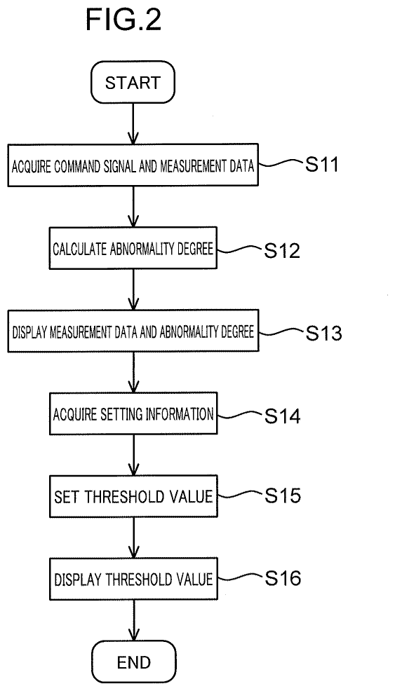

FIG. 2 is a flowchart showing processing executed by the information processing unit 21 for setting of the threshold value H.

First, in step S11, the data acquisition unit 31 acquires the command signal D1 for driving the servo motor 13 and the measurement data D3 measured for the servo motor 13 or the control target device 14 when the servo motor 13 operates on the basis of the command signal D1. The command signal D1 and the measurement data D3 to be acquired may be the command signal D1 and the measurement data D3 corresponding to one specific operation, or may be statistical values (for example, average values) of the command signal D1 and the measurement data D3 corresponding to a plurality of past operations. The command signal D1 and the measurement data D3 corresponding to a plurality of past operations are stored in a database as the command signal 42 and the measurement data 43 in the storage unit 25.

Next, in step S12, the calculation unit 32 inputs the command signal D1 and the measurement data D3 acquired in step S11 to the estimation model 41, and calculates the abnormality degree N of the operation of the servo motor 13 as an output from the estimation model 41. Note that a method of calculating the abnormality degree N by the calculation unit 32 is not limited to a method using the estimation model 41, and may be a rule-based calculation method or the like.

Next, in step S13, the display control unit 33 generates image data D5 including the measurement data D3 acquired in step S11 and the abnormality degree N calculated in step S12, and inputs the image data D5 to the display device 24 to cause the display device 24 to display the measurement data D3 and the abnormality degree N.

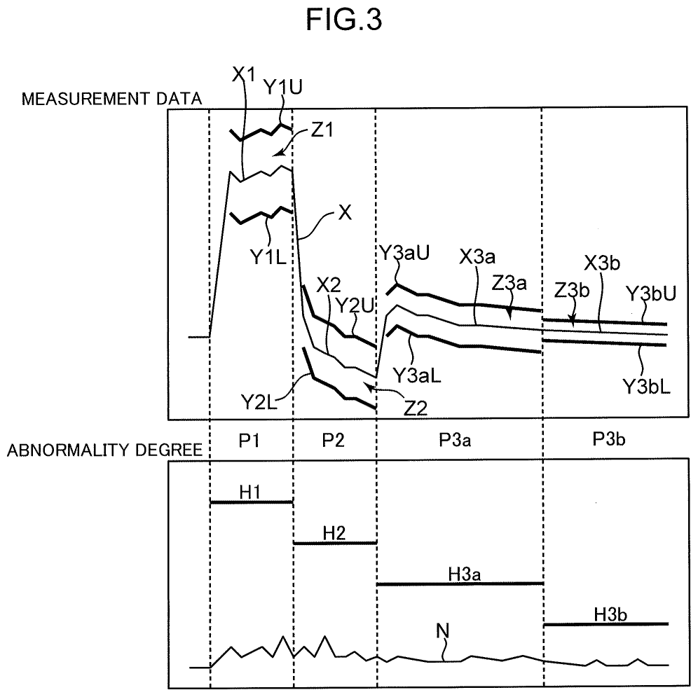

FIG. 3 is a diagram showing an example of a screen displayed on the display device 24.

On the display device 24, a screen indicating time-series measurement data X indicated by the measurement data D3 and a screen indicating the time-series abnormality degree N corresponding to the measurement data X are displayed side by side. For example, the horizontal axis of the screen indicating the measurement data X is time, and the vertical axis is a measurement value of the torque data.

An operation period of the servo motor 13 is divided into a plurality of operation periods P including an acceleration period P1, a deceleration period P2, and a constant-speed period P3. The constant-speed period P3 is divided into a transient period P3a including an initial phase of the constant-speed period P3 and a steady period P3b including an end period of the constant-speed period P3. The transient period P3a is a period in which a value of speed command data is zero but a measurement value of the torque data or speed data is greater than a predetermined value due to inertia. The steady period P3b is a period in which the measurement value of the torque data or the speed data becomes equal to or less than a predetermined value. The operation period is set by the period setting unit 37. The measurement data X includes measurement data X1 belonging to the acceleration period P1, measurement data X2 belonging to the deceleration period P2, measurement data X3a belonging to the transient period P3a, and measurement data X3b belonging to the steady period P3b.

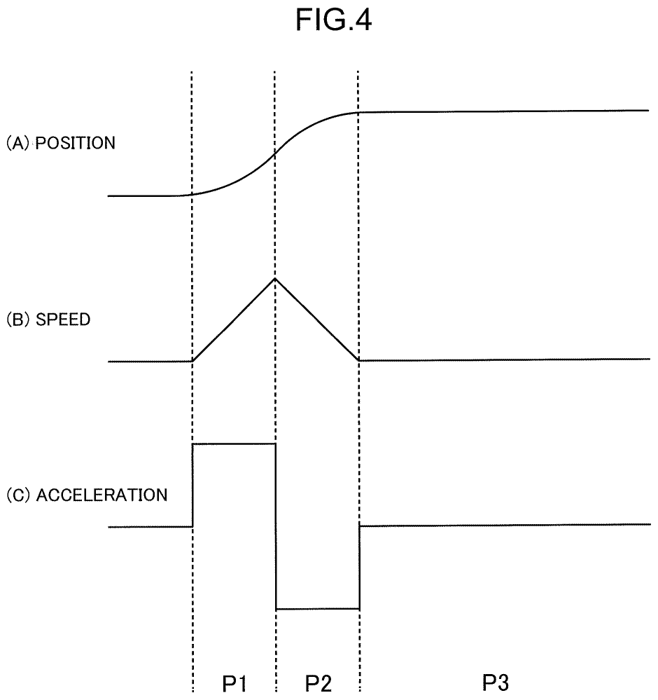

FIG. 4 is a diagram showing a setting example of the operation period P by the period setting unit 37. First, the period setting unit 37 acquires the position command signal included in the command signal D1 as shown in (A). Next, the period setting unit 37 calculates the speed command data by differentiating the position command signal as shown in (B). Then, the period setting unit 37 calculates acceleration command data by differentiating the speed command data as shown in (C). The period setting unit 37 sets, as the acceleration period P1, a period in which an absolute value of an acceleration is greater than or equal to a certain value and a sign is positive. The period setting unit 37 sets, as the deceleration period P2, a period in which the absolute value of the acceleration is greater than or equal to a certain value and a sign is negative. The period setting unit 37 sets, as the constant-speed period P3, a period in which the absolute value of the acceleration is less than a certain value. The period setting unit 37 sets, as the transient period P3a, a period before a lapse of a predetermined time from a start point of the constant-speed period P3, and sets, as the steady period P3b, a period after a lapse of a predetermined time from the start point of the constant-speed period P3. The period setting unit 37 may set, as the transient period P3a, a period in which the measurement value of the torque data is greater than or equal to the predetermined value in the constant-speed period P3, and may set, as the steady period P3b, a period in which the measurement value of the torque data is less than the predetermined value in the constant-speed period P3. The period setting unit 37 may set, as the transient period P3a, a period in which the measurement value of the speed data is greater than or equal to the predetermined value in the constant-speed period P3, and may set, as the steady period P3b, a period in which the measurement value of the speed data is less than the predetermined value in the constant-speed period P3.

Next, in step S14, the information acquisition unit 34 acquires, from the input device 23, the setting information D4 of an allowable range Z variably set by the user operation on the basis of the measurement data X displayed on the display device 24.

The user can set an allowable range Z1 defined by an upper limit Y1U and a lower limit Y1L for the acceleration period P1 by moving the measurement data X1 in the vertical direction by, for example, a mouse drag operation. The user can set an allowable range Z2 defined by an upper limit Y2U and a lower limit Y2L for the deceleration period P2 by moving the measurement data X2 in the vertical direction by, for example, a mouse drag operation. The user can set an allowable range Z3a defined by an upper limit Y3aU and a lower limit Y3aL for the transient period P3a by moving the measurement data X3a in the vertical direction by, for example, a mouse drag operation. The user can set an allowable range Z3b defined by an upper limit Y3bU and a lower limit Y3bL for the steady period P3b by moving the measurement data X3b in the vertical direction by, for example, a mouse drag operation. The information acquisition unit 34 acquires the setting information D4 of the allowable ranges Z1, Z2, Z3a, and Z3b from the input device 23.

Note that the allowable range Z may be set not only by a mouse drag operation but also by movement of a slider bar, numerical input, or the like. In the example of FIG. 3, the allowable range Z having the same width is set in an excess direction (upward direction) and a deficiency direction (downward direction) for the measurement data X. However, the width of the allowable range Z may be individually set in the excess direction and the deficiency direction. For example, in the acceleration period P1, the upper limit Y1U is set by dragging the measurement data X1 upward, the lower limit Y1L is set individually from the upper limit Y1U by dragging the measurement data X1 downward, and the allowable range Z1 defined by the upper limit Y1U and the lower limit Y1L is set.

Next, in step S15, the setting unit 35 sets the threshold value H for each operation period P on the basis of the setting information D4 acquired in step S14. The setting unit 35 sets the threshold value H according to a set width of the allowable range Z. In the example of FIG. 3, the setting unit 35 sets a largest threshold value H1 for the acceleration period P1 in which the setting width of the allowable range Z is the largest, and sets a next largest threshold value H2 for the deceleration period P2 in which the setting width of the allowable range Z is the next largest. The setting unit 35 sets a smallest threshold value H3b for the steady period P3b in which the setting width of the allowable range Z is the smallest, and sets a next smallest threshold value H3a for the transient period P3a in which the setting width of the allowable range Z is the next smallest.

In the operation during actual operation of the servo motor 13, the calculation unit 32 calculates the abnormality degree N by using the estimation model 41 on the basis of the command signal D1 and the measurement data D3. The determination unit 36 determines that the operation of the servo motor 13 is abnormal when the calculated abnormality degree N exceeds the threshold value H, and determines that the operation of the servo motor 13 is normal when the calculated abnormality degree N is equal to or less than the threshold value H.

When the allowable range Z is individually set in the excess direction and the deficiency direction for the measurement data X, the setting unit 35 individually sets the threshold value H in the excess direction and the deficiency direction.

Next, in step S16, the display control unit 33 causes the display device 24 to further display the threshold value H set in step S15 in association with the abnormality degree acquired in step S11. In the example of FIG. 3, the threshold values H1, H2, H3a, and H3b are displayed in association with the abnormality degree N.

In the display of the threshold value H, the display control unit 33 may increase or decrease the threshold value H in conjunction with the setting of the allowable range Z by the user operation and cause the display device 24 to display the threshold value H. For example, in a case where the user enlarges the set width of the allowable range Z1 by dragging the mouse, the display control unit 33 increases the threshold value H1 in real time in accordance with the enlargement of the set width of the allowable range Z1, and causes the display device 24 to display the changed threshold value H1. For example, in a case where the user reduces the set width of the allowable range Z2 by dragging the mouse, the display control unit 33 reduces the threshold value H2 in real time in accordance with the reduction of the set width of the allowable range Z2, and causes the display device 24 to display the changed threshold value H2.

Alternatively, the user may directly adjust the threshold value H by dragging the mouse or the like on the basis of the threshold value H displayed on the display device 24. For example, when the user moves the threshold value H1 upward by dragging the mouse, the information acquisition unit 34 acquires adjustment information including a moving direction and a moving amount of the threshold value H1 from the input device 23, and the setting unit 35 increases the set value of the threshold value H1 in accordance with the moving amount on the basis of the adjustment information. For example, when the user moves the threshold value H2 downward by dragging the mouse, the information acquisition unit 34 acquires adjustment information including a moving direction and a moving amount of the threshold value H2 from the input device 23, and the setting unit 35 decreases the set value of the threshold value H2 in accordance with the moving amount on the basis of the adjustment information.

At this time, the display control unit 33 may cause the display device 24 to display the allowable range Z by enlarging or reducing the allowable range Z in conjunction with the increase or decrease of the threshold value H by the user operation. For example, in a case where the user moves the threshold value H1 upward by dragging the mouse, the display control unit 33 enlarges the set width of the allowable range Z1 in real time in accordance with the increased threshold value H1, and causes the display device 24 to display the enlarged allowable range Z1. For example, in a case where the user moves the threshold value H2 downward by dragging the mouse, the display control unit 33 reduces the set width of the allowable range Z2 in real time in accordance with the decreased threshold value H2, and causes the display device 24 to display the reduced allowable range Z2.

In the present embodiment, the display control unit 33 causes the display device 24 to display the measurement data D3 and the abnormality degree N, and the information acquisition unit 34 acquires, from the input device 23, the setting information D4 of the allowable range Z variably set by a user operation on the basis of the displayed measurement data D3. As a result, the threshold value H for the determination unit 36 to determine whether the operation of the servo motor 13 is normal or abnormal can be variably set by a user operation.

In the present embodiment, the threshold values H1 to H3 are individually set for each operation period of the plurality of operation periods P1 to P3 to enable detailed abnormality detection.

In the present embodiment, the threshold values H3a and H3b are individually set for the transient period P3a and the steady period P3b to enable more detailed abnormality detection.

In the present embodiment, by the threshold value H is individually set in the excess direction and the deficiency direction for the measurement data D3 to enable detailed abnormality detection.

In the present embodiment, the threshold value H is increased or decreased in conjunction with the setting of the allowable range Z by the user operation and displayed on the display device 24 to improve convenience of the user.

In the present embodiment, since the threshold value H can be directly adjusted by the user operation in addition to the setting of the allowable range Z, the convenience of the user can be improved.

In the present embodiment, the allowable range Z is increased or decreased in conjunction with the adjustment of the threshold value H by the user operation and displayed on the display device 24 to further improve the convenience of the user.

In the present embodiment, the calculation unit 32 can calculate the abnormality degree N with high accuracy by using the machine-learned estimation model 41.

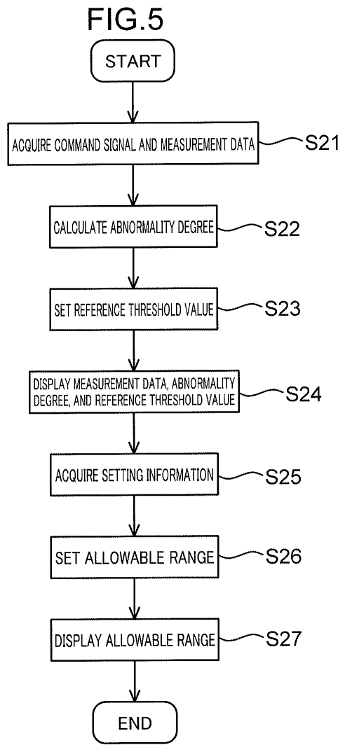

FIG. 5 is a flowchart showing processing executed by the information processing unit 21 according to a modification.

First, in step S21, as in step S11, the data acquisition unit 31 acquires the command signal D1 for driving the servo motor 13 and the measurement data D3 measured for the servo motor 13 or the control target device 14 when the servo motor 13 operates on the basis of the command signal D1.

Next, in step S22, as in step S11, the calculation unit 32 inputs the command signal D1 and the measurement data D3 acquired in step S21 to the estimation model 41, and calculates the abnormality degree N of the operation of the servo motor 13 as an output from the estimation model 41.

Next, in step S23, the setting unit 35 sets a reference threshold value H0 on the basis of the command signal S1 and the measurement data D3 acquired in step S21. For example, the setting unit 35 calculates a plurality of abnormality degrees N in time series on the basis of the command signal D1 and the measurement data D3, and sets, as the reference threshold value H0, a value obtained by adding k times a standard deviation o of the abnormality degree N to a maximum value of the abnormality degree N.

Next, in step S24, the display control unit 33 inputs the generated image data D5 to the display device 24 to cause the display device 24 to display the measurement data D3, the abnormality degree N, and the reference threshold value H0 in association with the abnormality degree N.

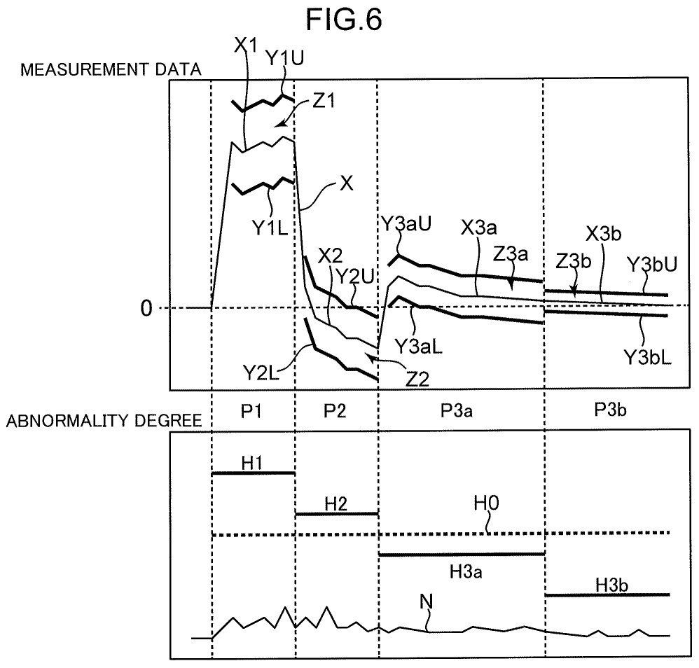

FIG. 6 is a diagram showing an example of a screen displayed on the display device 24. On the display device 24, a screen indicating time-series measurement data X indicated by the measurement data D3 and a screen indicating the time-series abnormality degree N corresponding to the measurement data X are displayed side by side. The reference threshold value H0 is displayed in association with the abnormality degree N.

Next, in step S25, the information acquisition unit 34 acquires, from the input device 23, the setting information D4 of the threshold value H variably set by the user operation on the basis of the reference threshold value H0 displayed on the display device 24.

For example, when the user moves the reference threshold value H0 in the acceleration period P1 upward by dragging the mouse, the information acquisition unit 34 acquires the setting information D4 including a moving direction and a moving amount of the reference threshold value H0 from the input device 23. The setting unit 35 sets the threshold value H1 greater than the reference threshold value H0 in accordance with the movement amount on the basis of the setting information D4. For example, when the user moves the reference threshold value H0 in the transient period P3a downward by dragging the mouse, the information acquisition unit 34 acquires the setting information D4 including the moving direction and the moving amount of the reference threshold value H0 from the input device 23. The setting unit 35 sets the threshold value H3a less than the reference threshold value H0 in accordance with the movement amount on the basis of the setting information D4.

Next, in step S26, the setting unit 35 sets the allowable range Z of the measurement data X on the basis of the threshold value H set for each operation period P.

Next, in step S27, the display control unit 33 causes the display device 27 to further display the allowable range Z set in step S26 in association with the measurement data X.

At this time, the display control unit 33 may cause the display device 24 to display the allowable range Z by enlarging or reducing the allowable range Z in conjunction with the movement of the reference threshold value H0 by the user operation. For example, in a case where the user moves the reference threshold value H0 in the acceleration period P1 upward by dragging the mouse, the display control unit 33 enlarges the set width of the allowable range Z1 in real time in accordance with the increased threshold value H1, and causes the display device 24 to display the enlarged allowable range Z1. For example, in a case where the user moves the reference threshold value H0 in the transient period P3a downward by dragging the mouse, the display control unit 33 reduces the set width of the allowable range Z3a in real time in accordance with the decreased threshold value H3a, and causes the display device 24 to display the reduced allowable range Z3a.

In the present modification, the display control unit 33 causes the display device 24 to display the measurement data X, the abnormality degree N, and the reference threshold value H0, and the information acquisition unit 34 acquires, from the input device 23, the setting information D4 of the threshold value H variably set by a user operation on the basis of the reference threshold value H0 displayed on the display device 24. As a result, the threshold value H for determining whether the operation of the servo motor 13 is normal or abnormal can be variably set by a user operation.

In this modification, the allowable range Z is increased or decreased in conjunction with the setting of the threshold value H by the user operation and displayed on the display device 24 to improve convenience of the user.

The present disclosure is widely applicable to a servo motor abnormality detection system.

1. An information processing method for setting a threshold value for determining whether an operation of a servo motor that controls a control target device is normal or abnormal, the method comprising: by an information processing device,
acquiring a command signal for driving the servo motor and measurement data measured for the servo motor or the control target device when the servo motor performs an operation on a basis of the command signal;
calculating an abnormality degree of the operation of the servo motor on a basis of the command signal and the measurement data;
causing a display device to display the measurement data and the abnormality degree;
acquiring, from an input device, setting information of an allowable range variably set by a user operation on a basis of the measurement data displayed;
setting the threshold value on a basis of the setting information; and
causing the display device to further display the threshold value set in association with the abnormality degree.

2. The information processing method according to claim 1, wherein
an operation period of the servo motor includes a plurality of operation periods including an acceleration period, a deceleration period, and a constant-speed period,
the allowable range is individually set for each of the plurality of operation periods, and
the threshold value is individually set for each of the plurality of operation periods.

3. The information processing method according to claim 2, wherein
the constant-speed period includes a transient period including an initial period of the constant-speed period and a steady period including an end period of the constant-speed period,
the allowable range is individually set for the transient period and the steady period, and
the threshold value is individually set for the transient period and the steady period.

4. The information processing method according to claim 1, wherein
the allowable range is individually set in an excess direction and a deficiency direction for the measurement data, and
the threshold value is individually set in the excess direction and the deficiency direction.

5. The information processing method according to claim 1, wherein in display of the threshold value, the threshold value is increased or decreased in conjunction with setting of the allowable range by the user operation and displayed on the display device.

6. The information processing method according to claim 1, further comprising
acquiring, from the input device, adjustment information of the threshold value variably adjusted by the user operation on a basis of the threshold value displayed; and
adjusting the threshold value set on a basis of the adjustment information.

7. The information processing method according to claim 6, further comprising increasing or decreasing the allowable range in conjunction with adjustment of the threshold value by the user operation and causing the display device to display the allowable range.

8. The information processing method according to claim 1, wherein in the calculating of the abnormality degree, the abnormality degree is calculated by using a machine-learned estimation model that estimates and outputs an abnormality degree on a basis of the command signal and the measurement data that have been input.

9. An information processing method for setting a threshold value for determining whether an operation of a servo motor for controlling a control target device is normal or abnormal, the method comprising: by an information processing device,
acquiring a command signal for driving the servo motor and measurement data measured by the servo motor or the control target device when the servo motor performs an operation on a basis of the command signal;
calculating an abnormality degree of the operation of the servo motor on a basis of the command signal and the measurement data;
setting a reference threshold value on a basis of the command signal and the measurement data;
causing a display device to display the measurement data, the abnormality degree, and the reference threshold value in association with the abnormality degree;
acquiring, from an input device, setting information of the threshold value variably set by a user operation on a basis of the reference threshold value displayed;
setting an allowable range of the measurement data on a basis of the threshold value set; and
causing the display device to further display the allowable range set in association with the measurement data.

10. The information processing method according to claim 9, wherein in displaying of the allowable range, the allowable range is increased or decreased in conjunction with setting of the threshold value by the user operation and displayed on the display device.

11. An information processing device that sets a threshold value for determining whether an operation of a servo motor that controls a control target device is normal or abnormal, the device comprising a processor, wherein the processer:
acquires a command signal for driving the servo motor and measurement data measured for the servo motor or the control target device when the servo motor performs an operation on a basis of the command signal;
calculates an abnormality degree of the operation of the servo motor on a basis of the command signal and the measurement data;
causes a display device to display the measurement data and the abnormality degree;
acquires, from an input device, setting information of an allowable range variably set by a user operation on a basis of the measurement data displayed; and
sets the threshold value on a basis of the setting information,
further causes the display device to display the threshold value set in association with the abnormality degree.

12. An information processing device that sets a threshold value for determining whether an operation of a servo motor for controlling a control target device is normal or abnormal, the device comprising a processor, wherein the processer:
acquires a command signal for driving the servo motor and measurement data measured by the servo motor or the control target device when the servo motor performs an operation on a basis of the command signal;
calculates an abnormality degree of the operation of the servo motor on a basis of the command signal and the measurement data;
sets a reference threshold value on a basis of the command signal and the measurement data;
causes a display device to display the measurement data, the abnormality degree, and the reference threshold value in association with the abnormality degree; and
acquires, from an input device, setting information of the threshold value variably set by a user operation on a basis of the reference threshold value displayed, further sets an allowable range of the measurement data on a basis of the threshold value set, and
further causes the display device to display the allowable range set in association with the measurement data.

13. A computer-readable non-transitory recording medium recording a program for causing an information processing device that sets a threshold value for determining whether an operation of a servo motor that controls a control target device is normal or abnormal to execute processing, to perform a process comprising:
acquires a command signal for driving the servo motor and measurement data measured for the servo motor or the control target device when the servo motor performs an operation on a basis of the command signal;
calculates an abnormality degree of the operation of the servo motor on a basis of the command signal and the measurement data;
causes a display device to display the measurement data and the abnormality degree;
acquires, from an input device, setting information of an allowable range variably set by a user operation on a basis of the measurement data displayed;
sets the threshold value on a basis of the setting information; and
causes the display device to further display the threshold value set in association with the abnormality degree.

14. A computer-readable non-transitory recording medium recording a program for causing an information processing device that sets a threshold value for determining whether an operation of a servo motor for controlling a control target device is normal or abnormal to execute processing, to perform a process comprising:
acquires a command signal for driving the servo motor and measurement data measured by the servo motor or the control target device when the servo motor performs an operation on a basis of the command signal;
calculates an abnormality degree of the operation of the servo motor on a basis of the command signal and the measurement data;
sets a reference threshold value on a basis of the command signal and the measurement data;
causes a display device to display the measurement data, the abnormality degree, and the reference threshold value in association with the abnormality degree;
acquires, from an input device, setting information of the threshold value variably set by a user operation on a basis of the reference threshold value displayed;
further sets an allowable range of the measurement data on a basis of the threshold value set; and
causes the display device to further display the allowable range set in association with the measurement data.
